(19) United States
(12) Patent Application Publication
(10) Pub. No.: US 2025/0146113 A1
(43) Pub. Date: May 8, 2025

(54) METHOD AND SYSTEM FOR DESIGNING SOLUTION HEAT-TREATMENT PROCESS OF SINGLE-CRYSTAL SUPERALLOY

(71) Applicant: Northwestern Polytechnical University, Shaanxi Province (CN)

(72) Inventors: Min Guo, Shaanxi Province (CN); Jia Chen, Shaanxi Province (CN); Jun Zhang, Shaanxi Province (CN); Min Yang, Shaanxi Province (CN); Yong Zhao, Shaanxi Province (CN)

(21) Appl. No.: 18/621,532

(22) Filed: Mar. 29, 2024

(30) Foreign Application Priority Data
Nov. 2, 2023 (CN) 202311449192.X

(51) Int. Cl. C22F 1/10; G01N 27/411

(52) U.S. Cl. CPC C22F 1/10; G01N 27/411

(57) ABSTRACT

The present disclosure discloses a method and system for designing a solution heat-treatment process of a single-crystal superalloy, and relates to the field of numerical simulation-material processing crossover techniques. The method includes: determining a solidus temperature distribution of an as-cast single-crystal superalloy sample based on a relationship between an element concentration and a solidus temperature according to an element concentration distribution extracted from the as-cast single-crystal superalloy sample; subjecting the as-cast single-crystal superalloy sample to solution heat-treatment simulation by a phase-field method to obtain a post-treatment element concentration distribution after a simulation time step of heat preservation at an incipient melting temperature; determining a segregation coefficient of each element; when segregation coefficients of all elements are within a preset range, denoting all incipient melting temperatures and corresponding current simulation times as solution heat-treatment simulation results; and determining an actual solution heat-treatment process of the as-cast single-crystal superalloy sample.

### CROSS REFERENCE TO RELATED APPLICATION

This patent application claims the benefit and priority of Chinese Patent Application No. 202311449192X, filed with the China National Intellectual Property Administration on Nov. 2, 2023, the disclosure of which is incorporated by reference herein in its entirety as part of the present application.

### TECHNICAL FIELD

The present disclosure relates to the field of numerical simulation-material processing crossover techniques, and in particular to a method and system for designing a solution heat-treatment process of a single-crystal superalloy.

### BACKGROUND

Single-crystal superalloys have a high strength and toughness, outstanding oxidation resistance and corrosion resistance, prominent processability, and excellent high-temperature comprehensive performance, and are the preferred materials for manufacturing turbine blades of advanced aero-engines. Single-crystal superalloys are usually produced by a directional solidification method, and there are interdendritic phases and element segregation (heterogenous element distribution) in as-cast microstructures of the single-crystal superalloys, which is unfavorable to high-temperature mechanical performance. In order to dissolve interdendritic phases and alleviate element segregation to obtain a homogeneous single phase, a solution heat-treatment is necessary. A temperature of the solution heat-treatment is particularly important. If the temperature is too low, it takes a lot of time to alleviate the element segregation and interdendritic phases are very likely to be insoluble. If the temperature is too high, although interdendritic phases can be dissolved in a short time and the element segregation can be alleviated, it will cause incipient melting (namely, local melting) to form solution pores, which will seriously weaken the high-temperature mechanical performance of an alloy.

In order to improve an efficiency of the solution heat-treatment, it is necessary to make the temperature of the solution heat-treatment as high as possible while ensuring no incipient melting. Therefore, the temperature of the solution heat-treatment needs to be lower than a temperature of incipient melting. However, the temperature of incipient melting is not a fixed value, and the temperature of incipient melting will continue to increase with the alleviation of element segregation during a solution heat-treatment process. The locality and variability of the temperature of incipient melting make a design of the solution heat-treatment complicated. Traditionally, a solution heat-treatment process is designed by an experimental method. In the experimental method, a holding temperature and a holding time are usually adjusted multiple times, and whether there is incipient melting is observed through microstructure characterization, such as to obtain an optimized solution heat-treatment process. For example, in the literature “H. T. Pang, L. J. Zhang, R. A. Hobbs, H. J. Stone, C. M. F. Rae. Solution heat treatment optimization of fourth-generation single-crystal nickel-base superalloys[J]. Metall. Mater. Trans. A., 2012, 43A: 3264-3282.”, a solution heat-treatment process of the fourth-generation nickel-based single-crystal superalloys LDSX-6B and LDSX-6C is optimized by an experimental method. However, the trial-and-error experimental method is time-consuming and labor-intensive, and a solution heat-treatment process designed by the trial-and-error experimental method is not generally applicable.

### SUMMARY

An objective of the present disclosure is to provide a method and system for designing a solution heat-treatment process of a single-crystal superalloy. In the present disclosure, a solution heat-treatment process of a single-crystal superalloy is designed based on simulation results, which has advantages such as short time, high efficiency, and low cost.

To allow the above objective, the present disclosure provides the following technical solutions:

In a first aspect, the present disclosure provides a method for designing a solution heat-treatment process of a single-crystal superalloy, including:
extracting an element concentration distribution from an as-cast single-crystal superalloy sample;
determining a solidus temperature distribution of the as-cast single-crystal superalloy sample based on a relationship between an element concentration and a solidus temperature according to the element concentration distribution;
denoting a minimum solidus temperature in the solidus temperature distribution as an incipient melting temperature, and determining a current simulation time;
subjecting the as-cast single-crystal superalloy sample to solution heat-treatment simulation by a phase-field method based on the incipient melting temperature to obtain a post-treatment element concentration distribution after a simulation time step of heat preservation at the incipient melting temperature;
determining a segregation coefficient of each element based on the post-treatment element concentration distribution;
when a segregation coefficient of any element is not within a preset range, updating the element concentration distribution to the post-treatment element concentration distribution, and returning to the step of determining a solidus temperature distribution of the as-cast single-crystal superalloy sample based on a relationship between an element concentration and a solidus temperature according to the element concentration distribution;
when segregation coefficients of all elements are within the preset range, denoting all incipient melting temperatures and corresponding current simulation times as solution heat-treatment simulation results; and
determining an actual solution heat-treatment process of the as-cast single-crystal superalloy sample based on the solution heat-treatment simulation results.

In a second aspect, the present disclosure provides a system for designing a solution heat-treatment process of a single-crystal superalloy, including:
an element concentration distribution extraction module configured to extract an element concentration distribution from an as-cast single-crystal superalloy sample;
a solidus temperature distribution determination module configured to determine a solidus temperature distribution of the as-cast single-crystal superalloy sample based on a relationship between an element concentration and a solidus temperature according to the element concentration distribution;
an incipient melting temperature determination module configured to denote a minimum solidus temperature in the solidus temperature distribution as an incipient melting temperature, and determine a current simulation time;
a solution heat-treatment simulation module configured to subject the as-cast single-crystal superalloy sample to solution heat-treatment simulation by a phase-field method based on the incipient melting temperature to obtain a post-treatment element concentration distribution after a simulation time step of heat preservation at the incipient melting temperature;
a segregation coefficient determination module configured to determine a segregation coefficient of each element based on the post-treatment element concentration distribution;
a solution heat-treatment simulation iteration module configured to: when a segregation coefficient of any element is not within a preset range, update the element concentration distribution to the post-treatment element concentration distribution, and return to the step of determining a solidus temperature distribution of the as-cast single-crystal superalloy sample based on a relationship between an element concentration and a solidus temperature according to the element concentration distribution;
a simulation result determination module configured to: when segregation coefficients of all elements are within the preset range, denote all incipient melting temperatures and corresponding current simulation times as solution heat-treatment simulation results; and
a solution heat-treatment process determination module configured to determine an actual solution heat-treatment process of the as-cast single-crystal superalloy sample based on the solution heat-treatment simulation results.

According to specific embodiments provided in the present disclosure, the present disclosure has the following technical effects:

The present disclosure discloses a method and system for designing a solution heat-treatment process of a single-crystal superalloy. The method is as follows: an element concentration distribution is extracted from an as-cast single-crystal superalloy sample, and then a solidus temperature distribution of the as-cast single-crystal superalloy sample is determined; a minimum solidus temperature in the solidus temperature distribution is denoted as an incipient melting temperature, and a current simulation time is determined; then solution heat-treatment simulation is conducted by a phase-field method, such that an element diffusion process of the single-crystal superalloy during a solution heat-treatment can be observed in real time to obtain a post-treatment element concentration distribution after a simulation time step at the incipient melting temperature; then a segregation coefficient of each element is determined; when segregation coefficients of all elements are within a preset range, all incipient melting temperatures and corresponding current simulation times are denoted as heat-treatment simulation results; and finally, an actual solution heat-treatment process of the as-cast single-crystal superalloy sample is determined based on the heat-treatment simulation results. In the present disclosure, based on the relationship between element concentration and solidus temperature, the real-time update of a solution heat-treatment temperature during a solution heat-treatment simulation process is allowed, and an optimized solution heat-treatment process can be obtained through a complete simulation process. Compared with the existing experimental methods, the method of the present disclosure has advantages such as short time, high efficiency, and low cost.

### BRIEF DESCRIPTION OF THE DRAWINGS

To describe the technical solutions in the embodiments of the present disclosure or in the prior art more clearly, the accompanying drawings required in the embodiments are briefly introduced below. Apparently, the accompanying drawings in the following description show merely some embodiments of the present disclosure, and a person of ordinary skill in the art may still derive other accompanying drawings from these accompanying drawings without creative efforts.

FIG. 1 is a schematic flow chart of the method for designing a solution heat-treatment process of a single-crystal superalloy in the present disclosure;

FIGS. 2A-2B show schematic diagrams of an as-cast microstructure of a single-crystal superalloy cast by directional solidification, where FIG. 2A is a schematic diagram of a dendritic morphology of the as-cast single-crystal superalloy due to an uneven element distribution and FIG. 2B is a schematic diagram of (γ+γ′) and (β+γ′) eutectic phases and a coarsened γ′ phase in the interdendritic regions;

FIGS. 3A-3C show schematic diagrams of concentration distributions of a refractory element W during a solution heat-treatment simulation process, where FIG. 3A is a schematic diagram of a concentration distribution obtained from the simulation time of 3,600 s, FIG. 3B is a schematic diagram of a concentration distribution obtained from the simulation time of 18,000 s, and FIG. 3C is a schematic diagram of a concentration distribution obtained from the simulation time of 72,000 s;

FIG. 4 is a schematic diagram of an isothermal solution heat-treatment process designed in Example 1;

FIG. 5 is a schematic diagram of a multi-step solution heat-treatment process designed in Example 2;

FIG. 6 is a schematic diagram of a slope solution heat-treatment process designed in Example 3;

FIGS. 7A-7C show schematic diagrams of microstructure obtained after solution heat-treatments with solution heat-treatment processes designed in three specific examples, where FIG. 7A is a schematic diagram of a microstructure obtained after a solution heat-treatment with a solution heat-treatment process designed in Example 1, FIG. 7B is a schematic diagram of a structure obtained after a solution heat-treatment with a solution heat-treatment process designed in Example 2, and FIG. 7C is a schematic diagram of a microstructure obtained after a solution heat-treatment with a solution heat-treatment process designed in Example 3; and

FIG. 8 is a schematic diagram of the system for designing a solution heat-treatment process of a single-crystal superalloy in the present disclosure.

### DETAILED DESCRIPTION OF THE EMBODIMENTS

The technical solutions of the embodiments of the present disclosure are clearly and completely described below with reference to the accompanying drawings in the embodiments of the present disclosure. Apparently, the embodiments are merely some rather than all of the embodiments of the present disclosure. All other embodiments obtained by a person of ordinary skill in the art based on the embodiments of the present disclosure without creative efforts shall fall within the protection scope of the present disclosure.

In order to make the objective, features, and advantages of the present disclosure clear and comprehensible, the present disclosure will be further described in detail below in combination with accompanying drawings and specific implementations.

### Embodiment 1

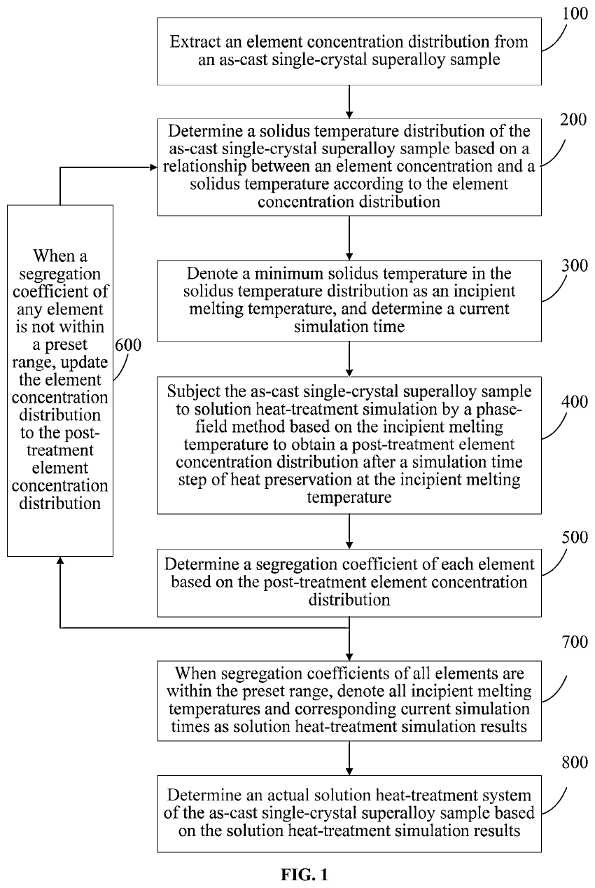

As shown in FIG. 1, the present disclosure provides a method for designing a solution heat-treatment process of a single-crystal superalloy, including:
S100: An element concentration distribution is extracted from an as-cast single-crystal superalloy sample, and specifically, the element concentration distribution of the as-cast single-crystal superalloy sample is measured by an electron probe micro-analyzer (EPMA).

Further, a withdrawal rate of directional solidification is 0.1 μm/s to 3,000 μm/s, an as-cast sample of the directional solidification is a single-crystal alloy, an as-cast microstructure of the alloy has a dendritic morphology and includes an interdendritic phase, and an element concentration distribution of the as-cast microstructure is measured by EPMA, which reflects both the element segregation and the interdendritic phase.

The method of the present disclosure is applicable to a single-crystal superalloy of any elemental composition. In an embodiment, elements extracted from the as-cast single-crystal superalloy sample include at least one selected from the group consisting of nickel, cobalt, chromium, molybdenum, tungsten, aluminum, tantalum, titanium, niobium, rhenium, ruthenium, and hafnium.
S200: A solidus temperature distribution of the as-cast single-crystal superalloy sample is determined based on a relationship between an element concentration and a solidus temperature according to the element concentration distribution.

The relationship between an element concentration and a solidus temperature is established by thermodynamic software, and a specific establishment process includes: a plurality of sets (at least 500 sets) of solidus temperatures of alloys with different element concentrations are calculated by thermodynamic calculation software, and element concentration data are subjected to non-linear fitting with solidus temperature data to obtain a corresponding functional relationship.

The relationship between an element concentration and a solidus temperature can be expressed by the following function:

$${T}_{s} = {\sum }_{i} {c}_{i} {P}_{i} + {\sum }_{i} {\sum }_{j > i} {c}_{i} {c}_{j} {\sum }_{r = 0}^{m} {{p}_{ij}^{r} ( {c}_{i} - {c}_{j} )}^{r} + {\sum }_{i} {\sum }_{j > i} {\sum }_{k > j} {c}_{i} {c}_{j} {c}_{k} {p}_{ijk}$$

where Tₛ represents a solidus temperature; i, j, and k each represent an element of the single-crystal superalloy; cᵢ, cⱼ, and cₖ represent a concentration of an element i of the single-crystal superalloy, a concentration of an element j of the single-crystal superalloy, and a concentration of an element k of the single-crystal superalloy, respectively; Pᵢ represents an interaction coefficient between the element i of the single-crystal superalloy and the element i of the single-crystal superalloy; pᵢⱼ represents an interaction coefficient between the element i of the single-crystal superalloy and the element j of the single-crystal superalloy; pᵢⱼₖ represents an interaction coefficient of the element i of the single-crystal superalloy and the element j of the single-crystal superalloy with the element k of the single-crystal superalloy; and m represents an order of an interaction between the element i of the single-crystal superalloy and the element j of the single-crystal superalloy, m is up to 2, namely, 0, 1, or 2, and r∈m.

The relationship between an element concentration and a solidus temperature is established to allow the real-time tracking of an incipient melting temperature during a solution heat-treatment simulation process, which provides a theoretical basis for the design of a solution heat-treatment process. Further, based on the above functional formula, the solidus temperature distribution of the as-cast single-crystal superalloy sample can be obtained according to the element concentration distribution of the as-cast single-crystal superalloy sample, or another solidus temperature distribution can be obtained according to a post-treatment element concentration distribution after a time step of solution heat-treatment simulation.
S300: A minimum solidus temperature in the solidus temperature distribution is denoted as an incipient melting temperature, and a current simulation time is determined, where the incipient melting temperature varies with an element concentration.

The step of determining a current simulation time specifically includes: 1) A number of times for returning to the step of determining a solidus temperature distribution of the as-cast single-crystal superalloy sample based on a relationship between an element concentration and a solidus temperature according to the element concentration distribution is acquired, and is denoted as a number of simulation times. 2) The number of simulation times is multiplied by a simulation time step to obtain the current simulation time.

Specifically, at the beginning, the number of times for returning cannot be acquired, that is, the number of simulation times is 0, in which case simulation is not started and a current simulation time is 0. If the number of times for returning acquired is 1, the number of simulation times is 1 (the simulation of S400 to S500 hereinafter has been completed once). The number of simulation times can be multiplied by the simulation time step to obtain the current simulation time. In addition, a value of the simulation time step needs to ensure that a calculation process of the solution heat-treatment simulation is stable. Therefore, the simulation time step in the present disclosure is 0.1 s to 10 s.
S400: The as-cast single-crystal superalloy sample is subjected to solution heat-treatment simulation by a phase-field method based on the incipient melting temperature to obtain a post-treatment element concentration distribution after a simulation time step of heat preservation at the incipient melting temperature.

Specifically, element homogenization simulation is conducted during a solution heat-treatment process using the incipient melting temperature as a simulated solution heat-treatment temperature. The post-treatment element concentration distribution after a simulation time step of heat preservation at the simulated solution heat-treatment temperature is obtained. A control equation of the phase-field method is shown in the following equation, and the control equation can be solved to obtain an evolution of an element concentration distribution over time.

The control equation of the phase-field method is as follows:

$$\frac{\partial {c}_{i}}{\partial t} = {\sum }_{j} ∇ \cdot ( {M}_{ij} ∇ \frac{δ F}{δ {c}_{j}} ) .$$

A thermodynamic free energy F of a system is related to a Gibbs free energy G, and thus F=G/Vₘ. G is solved by a calculated phase diagram method based on the following equation:

$$G = {\sum }_{i} {c}_{i} {G}_{i}^{fcc} + RT {\sum }_{i} {c}_{i} ln {c}_{i} + {\sum }_{i} {\sum }_{j > i} {c}_{i} {c}_{j} {{\sum }_{n = 0}^{m}}^{n} {{L}_{i , j}^{fcc} ( {c}_{i} - {c}_{j} )}^{n} + {\sum }_{i} {\sum }_{j > i} {\sum }_{k > j} {c}_{i} {c}_{j} {c}_{k} {L}_{i , j , k}^{fcc} .$$

A chemical mobility Mᵢⱼ is also solved by a calculated phase diagram method based on the following equation:

$${M}_{ij} = \frac{1}{{V}_{m}} {\sum }_{k} ( {δ}_{ik} - {c}_{i} ) ( {δ}_{jk} - {c}_{j} ) {c}_{k} {M}_{k} .$$

Mₖ is related to an atomic activation energy Qₖ, and is calculated based on the following equation:

$${M}_{k} = exp ( \frac{{Q}_{k}}{RT} ) \frac{1}{RT} .$$

In the above equations, cᵢ, cⱼ, and cₖ represent a concentration of an element i of the single-crystal superalloy, a concentration of an element j of the single-crystal superalloy, and a concentration of an element k of the single-crystal superalloy, respectively; Mᵢⱼ represents a chemical mobility; F represents a thermodynamic free energy of a system; G represents a Gibbs free energy; Vₘ represents a molar volume; Gᵢ^{fcc}, ⁿL_{i,j}^{fcc}, and L_{i,j,k}^{fcc} are acquired from a thermodynamic database; R represents a gas constant; T represents an absolute temperature, which is also a simulated solution heat-treatment temperature; m represents an order of an interaction between the element i of the single-crystal superalloy and the element j of the single-crystal superalloy; δᵢₖ and δⱼₖ represent a delta function; Mₖ represents an atomic migration rate; and Qₖ represents an atomic activation energy and is acquired from a dynamics database.

According to a specific embodiment of the present disclosure, after the solution heat-treatment simulation is run for a simulation time step, a post-treatment element concentration distribution at the simulated solution heat-treatment temperature for a di time can be obtained.
S500: A segregation coefficient of each element is determined based on the post-treatment element concentration distribution. The segregation coefficient refers to a ratio of an element concentration in the dendrite to an element concentration in the interdendritic region, and the closer the segregation coefficient is to 1, the higher the requirement of a solution heat-treatment. In the present disclosure, a preset range of the segregation coefficients is 0.9 to 1.1.
S600: When a segregation coefficient of any element is not within a preset range, the element concentration distribution is updated to the post-treatment element concentration distribution, and it is returned to the S200.
S700: When segregation coefficients of all elements are within the preset range, all incipient melting temperatures and corresponding current simulation times are denoted as solution heat-treatment simulation results. Specifically, one element concentration distribution obtained through phase-field simulation can be used to calculate an incipient melting temperature for another element concentration distribution, and then a solution heat-treatment temperature is updated (usually an updated solution heat-treatment temperature is higher the original solution heat-treatment temperature), thereby improving a solution heat-treatment efficiency.
S800: An actual solution heat-treatment process of the as-cast single-crystal superalloy sample is determined based on the solution heat-treatment simulation results. The actual solution heat-treatment process is a system in which a temperature and a time of a solution heat-treatment are variable.

The S800 specifically includes:
1) For any set of an incipient melting temperature and a corresponding current simulation time among the solution heat-treatment simulation results, a preset constant is subtracted from the incipient melting temperature to obtain an ideal temperature, where the ideal temperature and the corresponding current simulation time constitute an ideal solution heat-treatment result and a plurality of ideal solution heat-treatment results constitute an ideal solution heat-treatment process. Specifically, the preset constant can be determined according to a temperature control accuracy of an experimental solution heat-treatment furnace, and is usually not higher than 5° C. A solution heat-treatment temperature lower than an incipient melting temperature can prevent the occurrence of incipient melting.

Because a relationship between an ideal solution heat-treatment temperature and a time is presented as a curve, it is difficult to set up this system in a common solution heat-treatment furnace. Therefore, it is necessary to design a system with operability according to the relationship between an ideal solution heat-treatment temperature and a time, and the operability means that a temperature and a time of a solution heat-treatment can be set in a solution heat-treatment furnace.
2) Based on a principle that a temperature of a solution heat-treatment is not higher than the ideal temperature, the actual solution heat-treatment process is designed according to the ideal solution heat-treatment process. The actual solution heat-treatment process includes an isothermal solution heat-treatment (heat preservation is conducted at a fixed temperature), a multi-step solution heat-treatment (heat preservation is conducted first at a low temperature and then at a high temperature), and a slope solution heat-treatment (a solution heat-treatment temperature increases linearly over time).

Three specific examples based on the method of the present disclosure are given below and subjected to comparative analysis:

### Example 1

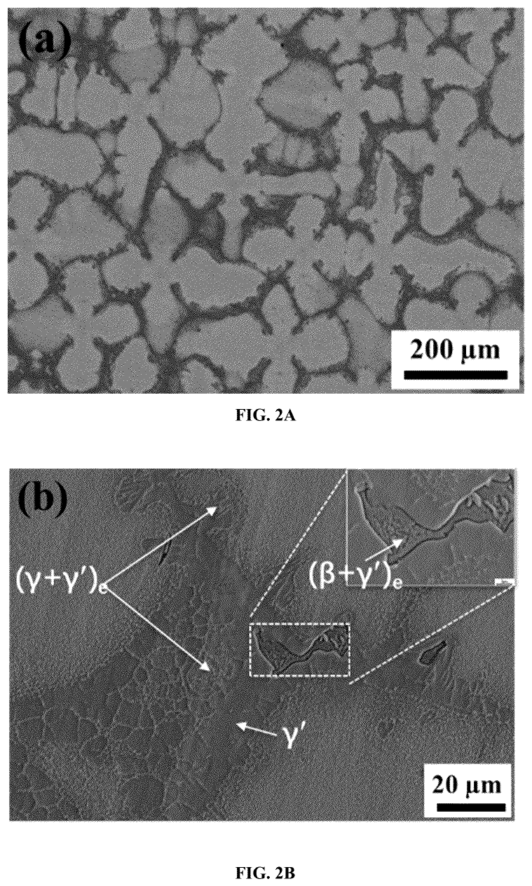

A cobalt-based single-crystal superalloy newly designed is taken as an example, and the cobalt-based single-crystal superalloy includes the following chemical components in atomic percentages (%): Ni: 30, Al: 11, W: 5, Ta: 1, Ti: 4, Cr: 5, and Co: the balance. When a single-crystal superalloy is prepared through directional solidification, a withdrawal rate is 100 μm/s, and a microstructure of a prepared as-cast sample is shown in FIGS. 2A-2B. It can be seen from FIG. 2A that the as-cast single-crystal superalloy has a dendrite morphology due to an uneven element distribution, and there are (γ+γ′) and (β+γ′) eutectic phases and a coarsened γ′ phase among dendrites (FIG. 2B).

A zone including an intact dendrite was selected and measured by EPMA to obtain an element concentration distribution of the as-cast sample. The element concentration distribution was converted into a matrix as an initial input of phase-field simulation, a solidus temperature distribution of the as-cast sample was calculated according to the established relationship between an element concentration and a solidus temperature, and a minimum solidus temperature was taken as an incipient melting temperature. Solution heat-treatment simulation was conducted with 1 s of heat preservation (time step) at the incipient melting temperature to obtain an element concentration distribution after 1 s. According to the simulated element concentration distribution, a solidus temperature distribution and an incipient melting temperature are calculated once again and the simulation was conducted once again until segregation coefficients of all elements were in a range of 0.9 to 1.1.

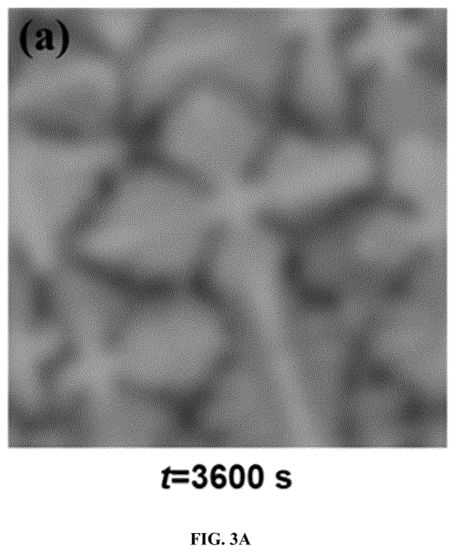

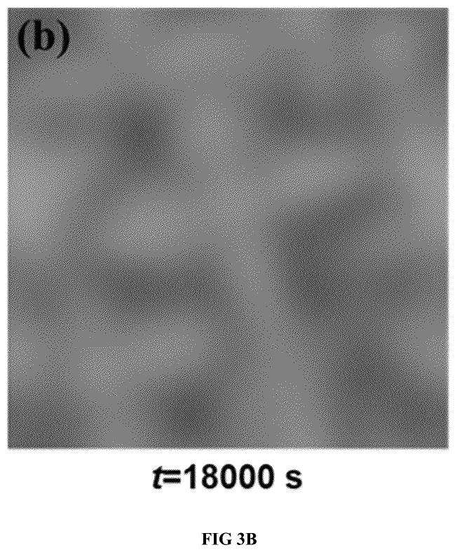

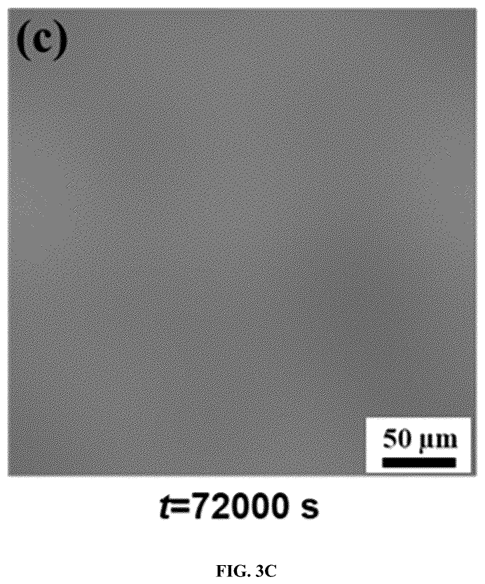

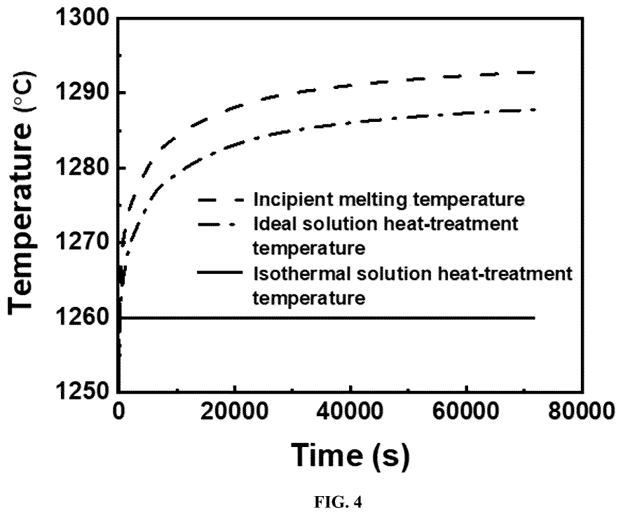

FIGS. 3A-3C show a homogenization process of an element W with a minimum diffusion rate during a solution heat-treatment simulation process, where FIG. 3A, FIG. 3B, and FIG. 3C are schematic diagrams obtained from simulation times of 3,600 s, 18,000 s, and 72,000 s, respectively. Based on an incipient melting temperature v curve during the solution heat-treatment simulation process shown by the dashed line in FIG. 4, an incipient melting temperature was reduced by 5° C. to obtain an ideal solution heat-treatment process shown by the dash-dot line in FIG. 4, and then an isothermal solution heat-treatment process shown by the solid line in FIG. 4 was designed accordingly.

### Example 2 and Example 3

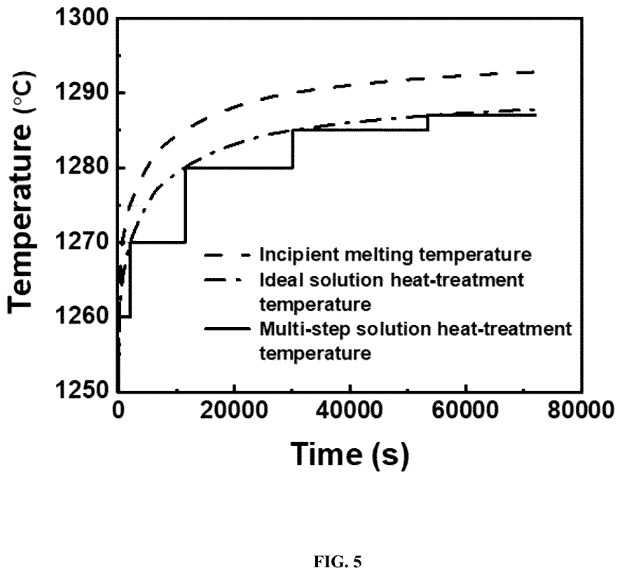

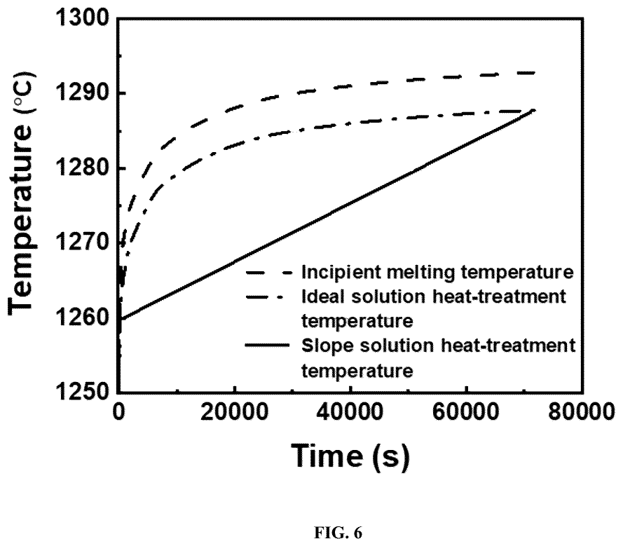

Example 2 and Example 3 were different from Example 1 in that a solution heat-treatment process with operability was designed according to an ideal solution heat-treatment process. A solution heat-treatment process designed in Example 2 is a multi-step solution heat-treatment process, which is specifically shown by the solid line in FIG. 5. A solution heat-treatment process designed in Example 3 is a slope solution heat-treatment process, which is specifically shown by the solid line in FIG. 6.

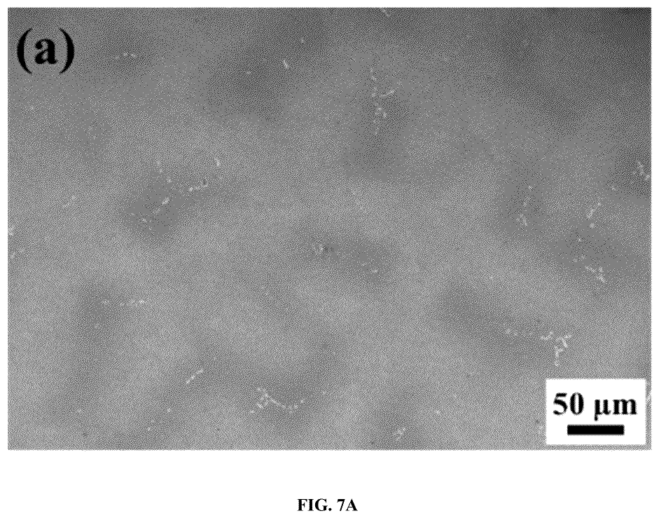

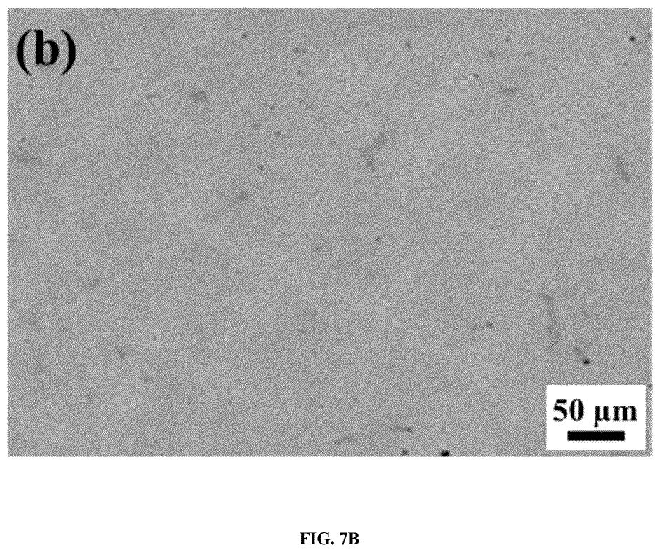

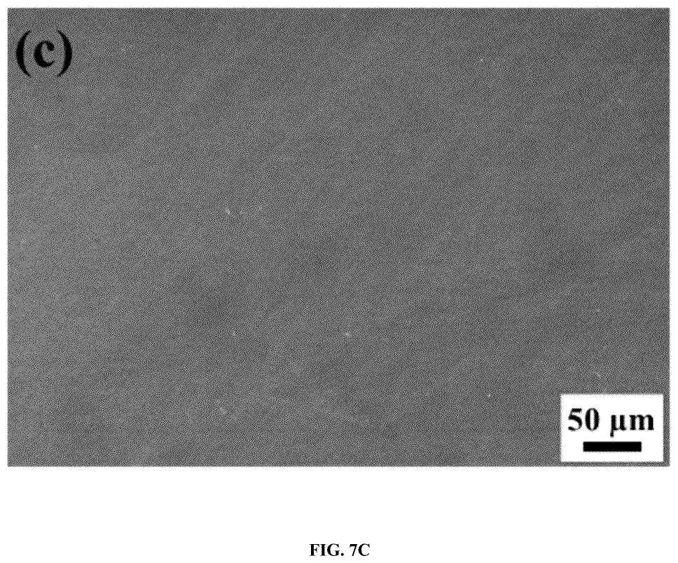

According to the solution heat-treatment processes designed in Examples 1 to 3, a corresponding solution heat-treatment experimental study was conducted. Specifically, samples obtained after solution heat-treatments with the solution heat-treatment processes in Examples 1 to 3 each were subjected to structural observation. Observation results are shown in FIGS. 7A-7C, where FIG. 7A is a schematic diagram of a structure obtained after a solution heat-treatment with the solution heat-treatment process designed in Example 1, FIG. 7B is a schematic diagram of a structure obtained after a solution heat-treatment with the solution heat-treatment process designed in Example 2, and FIG. 7C is a schematic diagram of a structure obtained after a solution heat-treatment with the solution heat-treatment process designed in Example 3. It can be seen from FIGS. 7A-7C that a solution heat-treatment process of a single-crystal superalloy designed by the method of the present disclosure will not make a sample undergo incipient melting during an experimental process, and the multi-step solution heat-treatment with a high temperature has the optimal solution heat-treatment effect, that is, a dendrite structure completely disappears and there is no interdendritic phase.

### Embodiment 2

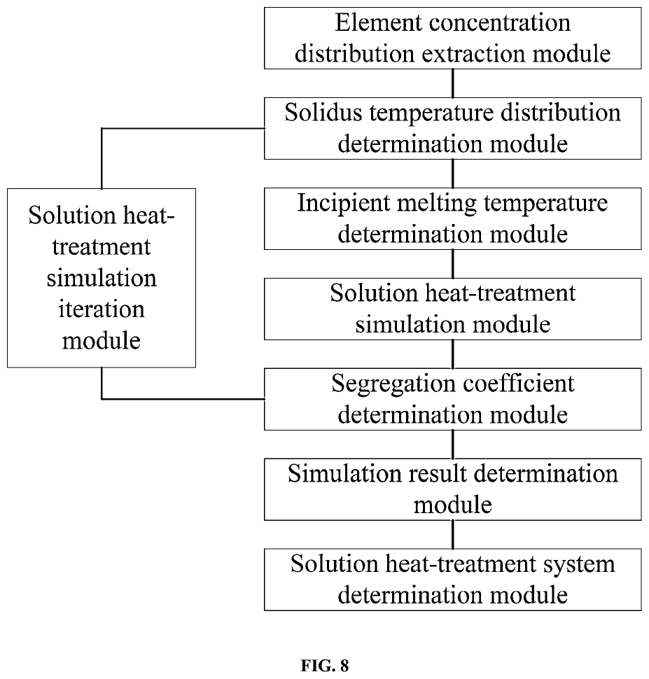

As shown in FIG. 8, in order to implement the technical solution in Embodiment 1 to allow a corresponding function and technical effect, this embodiment also provides a system for designing a solution heat-treatment process of a single-crystal superalloy, including:
an element concentration distribution extraction module configured to extract an element concentration distribution from an as-cast single-crystal superalloy sample;
a solidus temperature distribution determination module configured to determine a solidus temperature distribution of the as-cast single-crystal superalloy sample based on a relationship between an element concentration and a solidus temperature according to the element concentration distribution;
an incipient melting temperature determination module configured to denote a minimum solidus temperature in the solidus temperature distribution as an incipient melting temperature, and determine a current simulation time;
a solution heat-treatment simulation module configured to subject the as-cast single-crystal superalloy sample to solution heat-treatment simulation by a phase-field method based on the incipient melting temperature to obtain a post-treatment element concentration distribution after a simulation time step of heat preservation at the incipient melting temperature;
a segregation coefficient determination module configured to determine a segregation coefficient of each element based on the post-treatment element concentration distribution;
a solution heat-treatment simulation iteration module configured to: when a segregation coefficient of any element is not within a preset range, update the element concentration distribution to the post-treatment element concentration distribution, and return to the step of determining a solidus temperature distribution of the as-cast single-crystal superalloy sample based on a relationship between an element concentration and a solidus temperature according to the element concentration distribution;
a simulation result determination module configured to: when segregation coefficients of all elements are within the preset range, denote all incipient melting temperatures and corresponding current simulation times as solution heat-treatment simulation results; and
a solution heat-treatment process determination module configured to determine an actual solution heat-treatment process of the as-cast single-crystal superalloy sample based on the solution heat-treatment simulation results.

Each example of the present specification is described in a progressive manner, each example focuses on the difference from other examples, and the same and similar parts between the examples may refer to each other. Since the system disclosed in an example corresponds to the method disclosed in another example, the description is relatively simple, and reference can be made to the method description.

Specific examples are used herein to explain the principles and implementations of the present disclosure. The description of the examples is merely intended to help understand the method of the present disclosure and its core ideas. In addition, those of ordinary skill in the art can make various modifications to the specific implementations and application scope in accordance with the teachings of the present disclosure. In conclusion, the content of the present specification shall not be construed as a limitation to the present disclosure.

What is claimed is:

1. A method for designing a solution heat-treatment process of a single-crystal superalloy, comprising:
extracting an element concentration distribution from an as-cast single-crystal superalloy sample;
determining a solidus temperature distribution of the as-cast single-crystal superalloy sample based on a relationship between an element concentration and a solidus temperature according to the element concentration distribution;
denoting a minimum solidus temperature in the solidus temperature distribution as an incipient melting temperature, and determining a current simulation time;
subjecting the as-cast single-crystal superalloy sample to solution heat-treatment simulation by a phase-field method based on the incipient melting temperature to obtain a post-treatment element concentration distribution after a simulation time step of heat preservation at the incipient melting temperature;
determining a segregation coefficient of each element based on the post-treatment element concentration distribution;
when a segregation coefficient of any element is not within a preset range, updating the element concentration distribution to the post-treatment element concentration distribution, and returning to the step of determining a solidus temperature distribution of the as-cast single-crystal superalloy sample based on a relationship between an element concentration and a solidus temperature according to the element concentration distribution;
when segregation coefficients of all elements are within the preset range, denoting all incipient melting temperatures and corresponding current simulation times as solution heat-treatment simulation results; and
determining an actual solution heat-treatment process of the as-cast single-crystal superalloy sample based on the solution heat-treatment simulation results.

2. The method for designing a solution heat-treatment process of a single-crystal superalloy according to claim 1, wherein elements extracted from the as-cast single-crystal superalloy sample comprise at least one selected from the group consisting of nickel, cobalt, chromium, molybdenum, tungsten, aluminum, tantalum, titanium, niobium, rhenium, ruthenium, and hafnium.

3. The method for designing a solution heat-treatment process of a single-crystal superalloy according to claim 1, wherein the relationship between an element concentration and a solidus temperature is expressed by the following function:
$${T}_{s} = {\sum }_{i} {c}_{i} {P}_{i} + {\sum }_{i} {\sum }_{j > i} {c}_{i} {c}_{j} {\sum }_{r = 0}^{m} {{p}_{ij}^{r} ( {c}_{i} - {c}_{j} )}^{r} + {\sum }_{i} {\sum }_{j > i} {\sum }_{k > j} {c}_{i} {c}_{j} {c}_{k} {p}_{ijk}$$
wherein Tₛ represents a solidus temperature; i, j, and k each represent an element of the single-crystal superalloy; cᵢ, cⱼ, and cₖ represent a concentration of an element i of the single-crystal superalloy, a concentration of an element j of the single-crystal superalloy, and a concentration of an element k of the single-crystal superalloy, respectively; Pᵢ represents an interaction coefficient between the element i of the single-crystal superalloy and the element i of the single-crystal superalloy; Pᵢⱼ represents an interaction coefficient between the element i of the single-crystal superalloy and the element j of the single-crystal superalloy; Pᵢⱼₖ represents an interaction coefficient of the element i of the single-crystal superalloy and the element j of the single-crystal superalloy with the element k of the single-crystal superalloy; and m represents an order of an interaction between the element i of the single-crystal superalloy and the element j of the single-crystal superalloy, and r∈m.

4. The method for designing a solution heat-treatment process of a single-crystal superalloy according to claim 1, wherein a control equation of the phase-field method is as follows:
$$\frac{\partial {c}_{i}}{\partial t} = {\sum }_{j} ∇ \cdot ( {M}_{ij} ∇ \frac{δ F}{δ {c}_{j}} ) ; \\ F = G / {V}_{m} ; \\ G = {\sum }_{i} {c}_{i} {G}_{i}^{fcc} + RT {\sum }_{i} {c}_{i} ln {c}_{i} + {\sum }_{i} {\sum }_{j > i} {c}_{i} {c}_{j} {\sum }_{n = 0}^{m} {}^{n} {L}_{i , j}^{fcc} {( {c}_{i} - {c}_{j} )}^{n} + {\sum }_{i} {\sum }_{j > i} {\sum }_{k > j} {c}_{i} {c}_{j} {c}_{k} {L}_{i , j , k}^{fcc} ; \\ {M}_{ij} = \frac{1}{{V}_{m}} {\sum }_{k} ( {δ}_{ik} - {c}_{i} ) ( {δ}_{jk} - {c}_{j} ) {c}_{k} {M}_{k} ; and \\ {M}_{k} = exp ( \frac{{Q}_{k}}{RT} ) \frac{1}{RT} ,$$
wherein cᵢ, cⱼ, and cₖ represent a concentration of an element i of the single-crystal superalloy, a concentration of an element j of the single-crystal superalloy, and a concentration of an element k of the single-crystal superalloy, respectively; Mᵢⱼ represents a chemical mobility; F represents a thermodynamic free energy of a system; G represents a Gibbs free energy; Vₘ represents a molar volume; Gᵢ^{fcc}, ⁿL_{i,j}^{fcc}, and L_{i,j,k}^{fcc} are acquired from a thermodynamic database; R represents a gas constant; T represents a simulated solution heat-treatment temperature; m represents an order of an interaction between the element i of the single-crystal superalloy and the element j of the single-crystal superalloy; δᵢₖ and δⱼₖ represent a delta function; Mₖ represents an atomic migration rate;
and Qₖ represents an atomic activation energy and is acquired from a kinetic database.

5. The method for designing a solution heat-treatment process of a single-crystal superalloy according to claim 1, wherein the extracting an element concentration distribution from an as-cast single-crystal superalloy sample specifically comprises:
measuring the element concentration distribution of the as-cast single-crystal superalloy sample by an electron probe micro-analyzer (EPMA).

6. The method for designing a solution heat-treatment process of a single-crystal superalloy according to claim 1, wherein the determining a current simulation time specifically comprises:
acquiring a number of times for returning to the step of determining a solidus temperature distribution of the as-cast single-crystal superalloy sample based on a relationship between an element concentration and a solidus temperature according to the element concentration distribution, and denoting the number of times as a number of simulation times; and
multiplying the number of simulation times by the simulation time step to obtain the current simulation time,
wherein the simulation time step is 0.1 s to 10 s.

7. The method for designing a solution heat-treatment process of a single-crystal superalloy according to claim 1, wherein the determining an actual solution heat-treatment process of the as-cast single-crystal superalloy sample based on the solution heat-treatment simulation results specifically comprises:
for any set of an incipient melting temperature and a corresponding current simulation time among the solution heat-treatment simulation results, subtracting a preset constant from the incipient melting temperature to obtain an ideal temperature, wherein the ideal temperature and the corresponding current simulation time constitute an ideal solution heat-treatment result and a plurality of ideal solution heat-treatment results constitute an ideal solution heat-treatment process; and
based on a principle that a temperature of a solution heat-treatment is not higher than the ideal temperature, designing the actual solution heat-treatment process according to the ideal solution heat-treatment process.

8. The method for designing a solution heat-treatment process of a single-crystal superalloy according to claim 1, wherein the actual solution heat-treatment process is a system in which a temperature and a time of a solution heat-treatment are variable; and the actual solution heat-treatment process comprises an isothermal solution heat-treatment, a multi-step solution heat-treatment, and a slope solution heat-treatment.

9. The method for designing a solution heat-treatment process of a single-crystal superalloy according to claim 1, wherein the preset range of the segregation coefficients is 0.9 to 1.1.

10. A system for designing a solution heat-treatment process of a single-crystal superalloy, comprising:
an element concentration distribution extraction module configured to extract an element concentration distribution from an as-cast single-crystal superalloy sample;
a solidus temperature distribution determination module configured to determine a solidus temperature distribution of the as-cast single-crystal superalloy sample based on a relationship between an element concentration and a solidus temperature according to the element concentration distribution;
an incipient melting temperature determination module configured to denote a minimum solidus temperature in the solidus temperature distribution as an incipient melting temperature, and determine a current simulation time;
a solution heat-treatment simulation module configured to subject the as-cast single-crystal superalloy sample to solution heat-treatment simulation by a phase-field method based on the incipient melting temperature to obtain a post-treatment element concentration distribution after a simulation time step of heat preservation at the incipient melting temperature;
a segregation coefficient determination module configured to determine a segregation coefficient of each element based on the post-treatment element concentration distribution;
a solution heat-treatment simulation iteration module configured to: when a segregation coefficient of any element is not within a preset range, update the element concentration distribution to the post-treatment element concentration distribution, and return to the step of determining a solidus temperature distribution of the as-cast single-crystal superalloy sample based on a relationship between an element concentration and a solidus temperature according to the element concentration distribution;
a simulation result determination module configured to: when segregation coefficients of all elements are within the preset range, denote all incipient melting temperatures and corresponding current simulation times as solution heat-treatment simulation results; and
a solution heat-treatment process determination module configured to determine an actual solution heat-treatment process of the as-cast single-crystal superalloy sample based on the solution heat-treatment simulation results.
